(19) United States
(12) Patent Application Publication
(10) Pub. No.: US 2006/0079256 A1
(43) Pub. Date: Apr. 13, 2006

(54) Apparatus for measuring FA wireless communication propagation environment and method thereof

(76) Inventor: Kijong Kim, Seoul (KR)

Correspondence Address: John W. Renner;Renner, Otto, Boisselle & Sklar, LLP, Nineteenth Floor, 1621 Euclid Avenue, Cleveland, OH, 44115, US

(21) Appl. No.: 11/135,943

(22) Filed: May 24, 2005

(30) Foreign Application Priority Data
Sep. 20, 2004 (KR) 10-2004-0075141

(51) Int. Cl. H04Q 7/20

(52) U.S. Cl. 455/509

(57) ABSTRACT

Disclosed are an apparatus for measuring an FA wireless communication propagation environment and a method thereof which enables an FA measurer to easily measure the whole FA wireless communication propagation environment established between a base transceiver subsystem (BTS) and a mobile terminal at a certain place. If the FA change command is received from the PC while the terminal performs a wireless communication with the BTS through the FA determined by hashing the pre-input MIN number, the mobile terminal intercepts the FA determination by the hashing, and changes the FA according to the command from the PC. Then, if a system change command is input, the terminal changes the system, and reconnects by wireless to the BTS, so that the PC enables the FA measurer easily measure the whole FA-related wireless communication propagation environment allocated to a certain area.

### BACKGROUND OF THE INVENTION

1. Field of the Invention

The present invention relates to an apparatus for measuring an FA (Frequency Assignment) wireless communication propagation environment and a method thereof, and more particularly, to an apparatus for measuring an FA wireless communication propagation environment and a method thereof which enables an FA measurer to easily measure the whole FA wireless communication propagation environment established between a base transceiver subsystem (BTS) and a mobile terminal at a certain place.

2. Background of the Related Art

Generally, a mobile terminal that includes a mobile phone is a kind of mobile communication devices that can perform a wireless communication through a wireless connection with a BTS (Base Transceiver Subsystem) that serves as a repeater through an antenna. The mobile terminal has hardware such as an RF transmitting/receiving unit, a control unit, a memory unit, etc., and software for operating the hardware, and performs a wireless communication via the BTS. For this, the mobile terminal is allocated with its FA (Frequency Assignment) through its inherent mobile identification number (hereinafter referred to as a “MIN number”). Meanwhile, there are two wireless communication systems, i.e., a 2G (2^{nd} Generation or IS-95 A/B) system and a 3G (3^{rd} Generation or IS-2000 1×), and the mobile terminal selectively connects to either of the two systems. Basically, a mobile terminal made for use in the 3G system can connect to both the 2G and 3G systems, and a mobile terminal made for use in the 2G system can connect to the 2G system only.

The FA to the mobile terminal is performed through software having a hashing function that performs the allocation by hashing the MIN number. The hashing function is a method of expressing a command for calculating an address by changing a key value as an expression. In a mobile terminal, the FA is constantly allocated to a plurality of buckets by changing the key value of the MIN number, and the mobile terminal can perform a wireless communication through the allocated FA. Typically, 7 FAs are assigned to the 2G system and 9 FAs are assigned to the 1× system in Seoul. Also, 3 to 4 FAs are assigned to the 2G system and 4 to 5 FAs are assigned to the 1× system in districts. This number corresponds to the number of buckets, and the FAs are uniformly assigned to the buckets by the hashing function. Accordingly, the mobile phone performs a wireless communication through one FA allocated by the MIN number.

Accordingly, an FA measurer who measures the FA wireless communication propagation environment established between the mobile terminal and the BTS has no choice but to measure only one FA wireless communication propagation environment through one mobile terminal. If the FA measurer intends to measure another FA wireless communication propagation environment at a certain place, he/she should find the MIN number for the FA subject to measurement and input the MIN number to the mobile terminal, or should carry all the mobile terminals corresponding to the FA.

Consequently, when the FA measurer visits the spot in order to solve the client's dissatisfaction, he/she should secure the terminal having the same FA as the client's terminal. Although the FA measurer secures the same terminal, it takes a lot of time in performing the measurement test with the anxiety about leaking of client's information.

### SUMMARY OF THE INVENTION

Accordingly, the present invention is directed to an apparatus for measuring an FA (Frequency Assignment) wireless communication propagation environment and a method thereof that substantially obviate one or more problems due to limitations and disadvantages of the related art.

It is an object of the present invention to provide an apparatus for measuring an FA (Frequency Assignment) wireless communication propagation environment and a method thereof which enable an FA measurer to easily measure the whole system and the whole FA wireless communication propagation environment established between a base transceiver subsystem (BTS) and a mobile terminal at a certain place.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

In order to achieve the above and other objects, there is provided an apparatus for measuring an FA (Frequency Assignment) wireless communication propagation environment established between a BTS (Base Transceiver Subsystem) and a mobile terminal at a certain place, according to the present invention, which comprises the mobile terminal for performing a wireless communication with the BTS by an FA determined by hashing a pre-input MIN (Mobile Identification Number), and obtaining FA-related wireless communication propagation environment information by changing a system or the FA according to a system change command or an FA change command received from a PC linked to the mobile terminal if the system change command or the FA change command is sent from the PC, and the PC linked to the mobile terminal and programmed to send the system change command or the FA change command to the mobile terminal, to read the FA-related wireless communication propagation environment information received from the BTS through the mobile terminal and to output the read FA-related wireless communication propagation environment information in the form of a graph and so on for monitoring.

In another aspect of the present invention, there is provided a method of measuring an FA (Frequency Assignment) wireless communication propagation environment established between a BTS (Base Transceiver Subsystem) and a mobile terminal that is linked to a PC at a certain place, which comprises the steps of the mobile terminal obtaining FA-related wireless communication propagation environment information from the BTS through an FA determined by hashing a pre-input MIN (Mobile Identification Number); the PC receiving the FA-related wireless communication propagation environment information from the mobile terminal and outputting the FA-related wireless communication propagation environment information in the form of a readable graph and so on for monitoring; the PC sending a command for changing a system to the mobile terminal, the mobile terminal changing the system according to the command for changing the system that is received from the PC, obtaining wireless communication propagation environment information related to the changed system and outputting the obtained system-related wireless communication propagation environment information to the PC; and the PC sending a command for changing the FA to the mobile terminal, the mobile terminal changing the FA according to the command from the PC and obtaining wireless communication propagation environment information related to the changed FA from the BTS, and the PC re-outputting the FA-related wireless communication propagation environment information in the form of a graph and so on based on the FA-related wireless communication propagation environment information transmitted from the mobile terminal.

It is preferable that if the system change command or the FA change command is sent from the PC while the mobile terminal initiates the system through its power-on, determines the FA by hashing the pre-input MIN and is in a standby state that a wireless communication with the BTS is possible by the FA, the mobile terminal moves to the standby state for reception and changes the system or the FA sent from the PC.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an apparatus for measuring an FA wireless communication propagation environment according to the present invention;

FIG. 2 is a block diagram illustrating the construction of the apparatus for measuring an FA wireless communication propagation environment according to the present invention;

FIG. 3 is a flowchart illustrating a method of measuring an FA wireless communication propagation environment according to the present invention;

FIG. 4 is a flowchart illustrating a process of changing an FA through a mobile terminal; and

FIGS. 5 and 6 are views illustrating examples of tool windows according to the present invention.

### DETAILED DESCRIPTION OF THE PREFERRED EMBODIMENT

The apparatus for measuring an FA (Frequency Assignment) wireless communication propagation environment and the method thereof according to the preferred embodiment of the present invention will now be explained in detail with reference to the accompanying drawings.

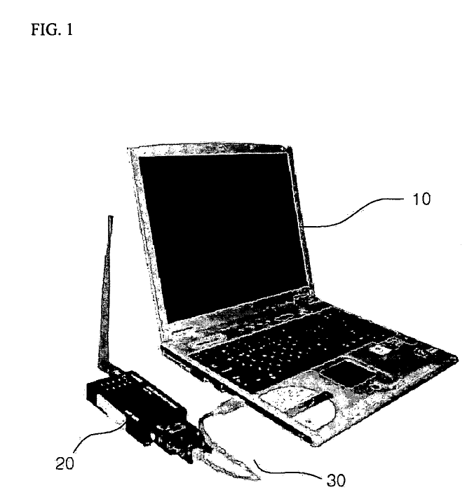

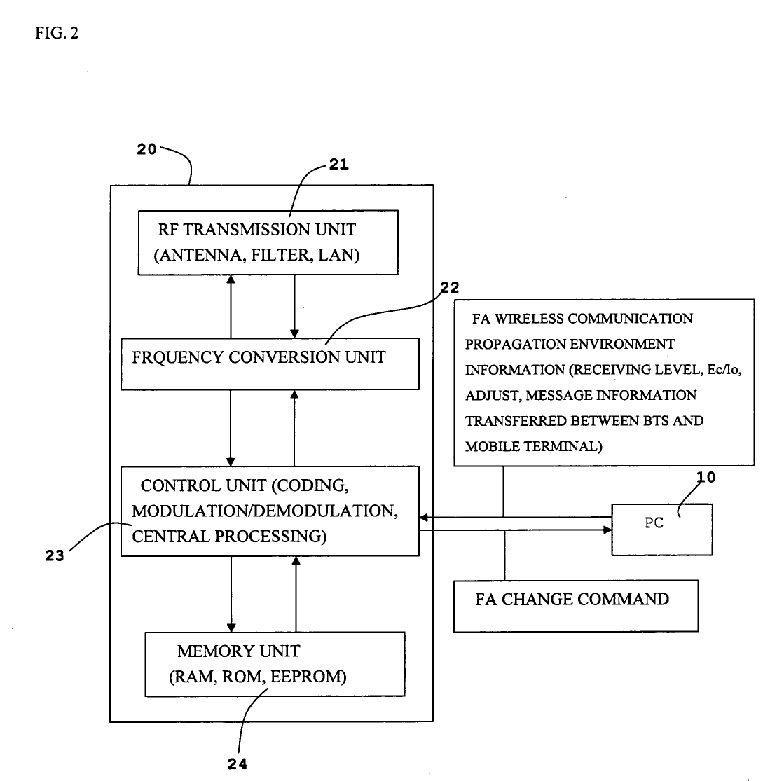

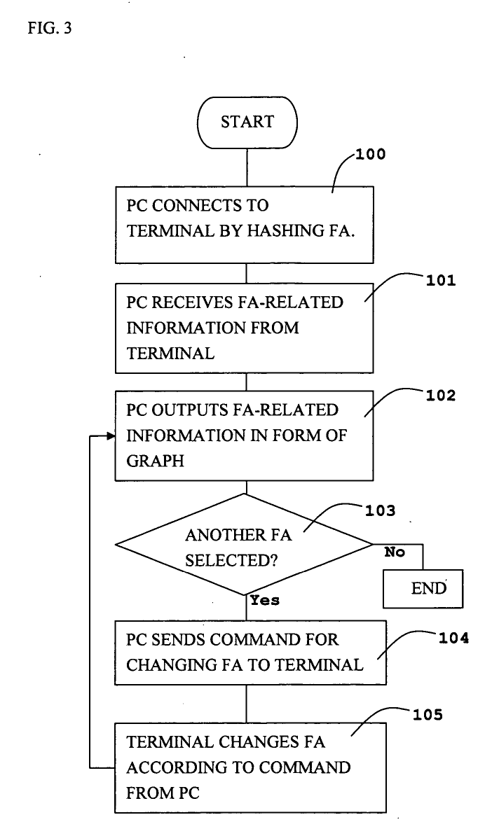

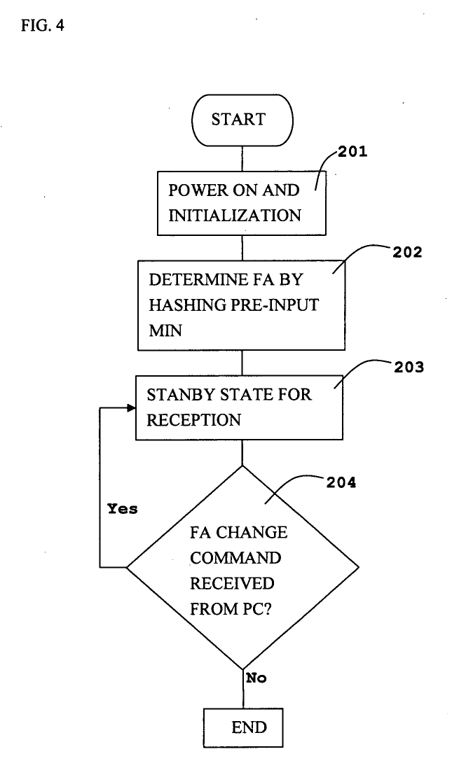

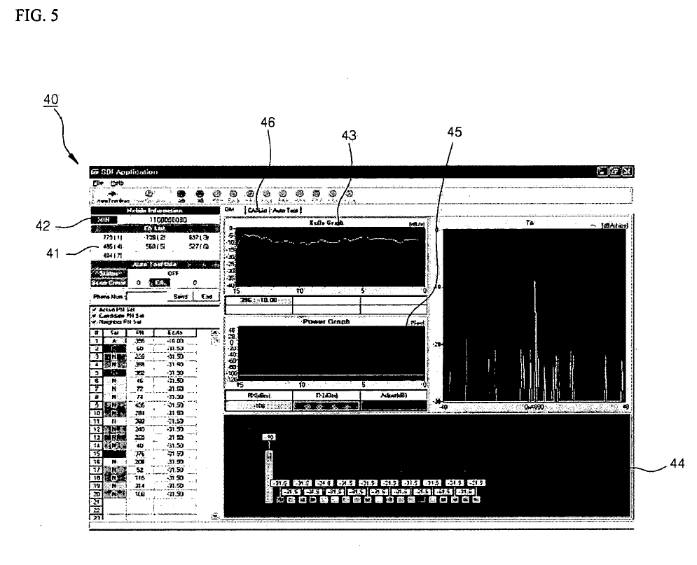

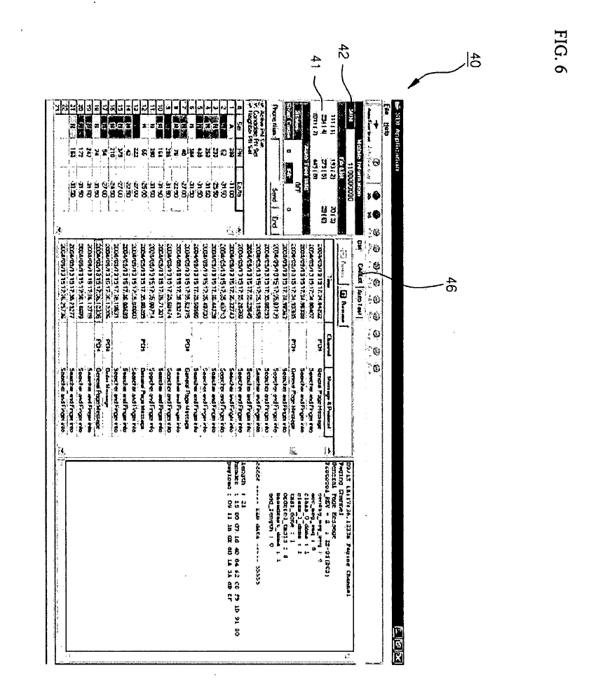

FIG. 1 is a view illustrating an apparatus for measuring an FA wireless communication propagation environment according to the present invention, and FIG. 2 is a block diagram illustrating the construction of the apparatus for measuring an FA wireless communication propagation environment according to the present invention. FIG. 3 is a flowchart illustrating a method of measuring an FA wireless communication propagation environment according to the present invention, and FIG. 4 is a flowchart illustrating a process of changing an FA through a mobile terminal. FIGS. 5 and 6 are views illustrating examples of tool windows according to the present invention.

As illustrated in the accompanying drawings, the apparatus for measuring an FA wireless communication propagation environment according to the present invention briefly includes a PC 10, and a mobile terminal 20 linked to the PC 10.

The PC 10 may include a desk top, a notebook computer, etc., measures an FA (Frequency Assignment) wireless communication propagation environment using the mobile terminal 20 linked thereto, and outputs a result of measurement. As illustrated in FIGS. 5 and 6, the PC 10 displays a tool window 40 on its output device, and makes the tool window 40 measure the FA wireless communication propagation environment and output the result of measurement. The PC 10 is a well known device, and thus the detailed explanation thereof will be omitted. The PC 10 may have Window98/Me/2000/2003/Xp set thereon as an OS.

The terminal 20 is provided with an RF transmission/reception unit 21, a frequency conversion unit 22, a control unit 23 and a memory unit 24, and performs a wireless communication with the BTS in the same manner as a typical mobile phone. Accordingly, the terminal 20 may be called a mobile phone.

The RF transmission/reception unit 21 includes an antenna, a filter and an LNA, and serves to transmit/receive signals in free space in order to perform a wireless communication with the BTS. Additionally, the RF transmission/reception unit 21 serves to remove noise and to keep the signal in uniform size and strength. Specifically, the antenna adjusts the strength of the transmitted signal, the LNA adjusts the strength of the received signal, and the filter filters the signal.

The frequency conversion unit 20 (including UPC, DNC, A/D and D/A) converts an analog signal into a digital signal and vice versa, and converts the frequency of the signal into a high/low frequency signal.

The control unit 23 is a CDMA type main unit that includes function of coding, modulation/demodulation and central processing, and mainly serves to convert the audio signal into a coded digital signal or convert a digital signal into an audio signal.

The memory unit 24 (including RAM, ROM and EEPROM) stores an OS for operating hardware as described above or general software and data.

The terminal 20 having the above-described construction connects by wireless to the BTS so that the PC 10 can measure the FA wireless communication propagation environment, and changes the system or FA according to a command of the PC 10 so that the PC 10 can measure the whole FA wireless communication propagation environment. Specifically, the terminal 20 changes the system or the FA, and transmits FA-related wireless communication propagation environment information, which is established between the terminal and the BTS, according to the command of the PC 10. Accordingly, the PC 10 measures the FA wireless communication propagation environment based on the above-described information.

The FA-related wireless communication propagation environment information transmitted from the terminal 20 to the PC 10 includes a receiving level, Ec/lo, adjust, message information transferred between the BTS and the terminal, etc., and the PC 10 measures the FA wireless communication propagation environment based on the information.

The terminal 20 is connected to an RS-232C port of the PC 10, and uses a separate external power supply or the USB power of the PC 10. It is preferable that a connection cable 30 comprises a DM cable.

Hereinafter, a method of measuring an FA wireless communication propagation environment through the above-described system according to the present invention will be explained.

First, the PC 10 connects to the terminal 20, which connects by wireless to the BTS, through the FA determined by hashing the pre-input mobile identification number (MIN) (step 100).

The terminal 20 connects by wireless to the BTS through the FA determined by hashing and assigning the pre-input MIN through an algorithm of the hashing function, and the PC 10 is linked to the terminal 20 in this state. The terminal 20 obtains the FA-related wireless communication propagation environment information such as a receiving level, Ec/lo, adjust, message information transferred between the BTS and the terminal, etc., from the BTS. The FA-related wireless communication propagation environment information as obtained above is transmitted from the terminal 20 to the PC 10 (step 101), and the PC 10 outputs the transmitted FA-related wireless communication propagation environment information in the form of a readable graph and so on (step 102).

As illustrated in FIG. 5, the PC 10 outputs a tool window on its output device, and the FA-related wireless communication propagation environment information is output through the tool window 40 in the form of a graph and so on.

For example, if the area of which the FAs are to be measured is Seoul, 7 FAs given to the 2G system for Seoul are output through an FA list window 41 in the tool window 40, and the MIN number used to determine the FAs is output through a MIN window 41.

Additionally, through an FA list window 42, FAs determined by the terminal's hashing of the MIN number output through the MIN window 42, for example, ‘2FA’ are displayed in the form of a box. Accordingly, the terminal 20 performs a wireless communication with the BTS by 2FA of the 2G system, and transmits the wireless communication environment information to the PC 10 in real time. The PC 10 outputs the result of measurement to the tool window 40 based on the 2FA-related wireless communication propagation information transmitted from the terminal 20 in the form of a graph and so on.

Through an Ec/lo graph window 43 in the tool window 40, the Ec/lo value of an active set caught by the terminal 20 is displayed in the form of a graph. The vertical axis represents the Ec/lo values [dB] of the PN, and the horizontal axis represents time (sec).

Through a PN list graph window 44, information about the pilot set being managed by the terminal 20 is displayed in the form of a line graph. The PN graph is composed of a PN offset of the PN, a graph for outputting the Ec/lo, and a grid for outputting information of the respective PNs. In the Ec/lo graph window 43, the Ec/lo state of the PN being managed by the terminal 20 is displayed in the form of a graph. The grid is a place where the respective PN information is displayed, and is divided into a PN set, a PN offset, an EC/lo, and a BTS name. The PN set is discriminated by colors. For example, yellow indicates an active set, pink a candidate set, sky blue a neighbor set, respectively.

A power graph window 45 is for displaying power information Rx, Tx and Tx adjust power of the terminal 20. In the power graph window 45, Tx, Tx adjust power are displayed only when the terminal 20 is in a calling state, X axis represents time (sec), and Y axis represents dB or dBm.

If a CAI (Common Air Interface) button 46 is clicked, as shown in FIG. 6, a message and value subject to measurement in the 2FA-related wireless communication propagation environment information being transmitted from the terminal 20 are displayed by time zones.

As described above, the PC 10 displays the FA-related measurement values presently determined from the terminal 20 in a diverse manner through the tool window 40, and the FA measurer can check and read the FA-related wireless communication propagation environment through the tool window 40.

If the FA measurer selects another system through the tool window in this state, the PC sends a command for changing the present system to the selected system to the terminal, and the terminal changes the system and connects by wireless to the BTS of the selected system. Meanwhile, if another FA is selected (step 103), the PC 10 sends a command for changing the present FA to the selected FA to the terminal 20 (step 104), and the terminal 20 changes the present FA to the commanded FA and connects by wireless to the BTS of the changed FA (step 105).

As described above, while the terminal 20 performs a wireless communication with the BTS through the changed system or FA, it obtains the wireless communication propagation environment information related to the changed system or FA, and transmits the obtained information to the PC 10. Accordingly, the PC 10 outputs the result of measurement of the wireless communication propagation environment related to the changed FA, which is transmitted from the terminal 20, in the tool window 40. By repeating this process, the PC 10 can easily measure the whole FA wireless communication propagation environment allocated to a certain place through the terminal 20.

For example, if an FA measurer clicks ‘7FA (404[7] in the drawing)’ among the whole FAs of Seoul area in the FA list 41 of 2G system being displayed on the tool window using a mouse, the PC 10 recognizes the ‘7FA’ and sends a command for changing the present 2FA to 7FA to the terminal 20.

Accordingly, the terminal 20 changes the present ‘2FA’ to ‘7FA’ by executing the corresponding program, connects by wireless to the BTS for the ‘7FA’, and obtains the ‘7FA’-related wireless communication propagation environment information from the BTS. Then, the terminal 20 transmits the obtained information to the PC 10. The PC 10 displays the ‘7FA’-related wireless communication propagation environment information transmitted from the terminal 20 in the form of a graph and so on in the tool window 40 so that the FA measurer can read and monitor the information through the tool window 40. By repeating this process, the FA measurer who is in a certain place can measure the wireless communication propagation environments of the 7 FAs assigned to Seoul area.

If the FA measurer clicks an icon of ‘3G system’ in order to measure the FA wireless communication propagation environment of the 3G system in this case, the PC 10 sends a command for changing to the 3G system to the terminal 20, and the terminal 20 changes the present system to the 3G system, and transmits the wireless communication propagation environment information to the PC.

As illustrated in FIG. 3, the terminal 20 changes the system and the FA commanded by the PC 10 by proceeding with the following process.

The terminal 20 transmits the FA-related wireless communication propagation environment information to the PC 10 through steps of initializing and determining the system through a power-on, determining FAs by hashing the input MIN number (step 202), and waiting to receive information from the BTS with respect to the determined FAs (step 203). For example, the terminal determines ‘2FA’ by hashing the MIN number indicated in the MIN window 42 of the tool window 40, performs a wireless communication with the BTS through ‘2FA’, and transmit the ‘2FA’-related wireless communication environment information received from the BTS to the PC 10.

Specifically, if a power is applied to the terminal 20 (i.e., booting), the terminal 20 sets the RAM by reading system information required for the EEPROM, performs the system synchronization using the pilot channel and sync channel, and receives information required for the system from the BTS to initialize the system. Then, the terminal 20 receives a CDMA channel list (i.e., FA list) of a certain area from the BTS, determines the FAs by hashing the pre-input MIN number, and connects by wireless to the BTS through the determined FAs to be in a standby state for reception. In this standby state, the terminal 20 continuously receives the paging channel, i.e., the FA-related wireless communication propagation environment information continuously transmitted from the BTS, and transmits the received information to the PC 10.

Thereafter, if a command for changing the system or FA is input from the PC 10 (step 204), the terminal 20 enters into the standby state that the wireless communication with BTS is possible (step 203), changes the FA according to the command, and obtains the wireless communication propagation environment information related to the changed FA from the BTS to transmit the obtained information to the PC 10.

As described above, according to the present invention, if the FA change command is received from the PC while the terminal performs a wireless communication with the BTS through the FA determined by hashing the pre-input MIN number, it intercepts the FA determination by the hashing, and changes the FA according to the command from the PC. Then, if a system change command is input, the terminal changes the system, and reconnects by wireless to the BTS, so that the PC enables the FA measurer easily measure the whole FA-related wireless communication propagation environment allocated to a certain area through one terminal.

While the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. A method of measuring an FA (Frequency Assignment) wireless communication propagation environment established between a BTS (Base Transceiver Subsystem) and a mobile terminal that is linked to a PC at a certain place, the method comprising the steps of:
the mobile terminal obtaining FA-related wireless communication propagation environment information from the BTS through an FA determined by hashing a pre-input MIN (Mobile Identification Number);
the PC receiving the FA-related wireless communication propagation environment information from the mobile terminal and outputting the FA-related wireless communication propagation environment information in the form of a readable graph and so on for monitoring;
the PC sending a command for changing a system to the mobile terminal, the mobile terminal changing the system according to the command for changing the system that is received from the PC, obtaining wireless communication propagation environment information related to the changed system and outputting the obtained system-related wireless communication propagation environment information to the PC; and
the PC sending a command for changing the FA to the mobile terminal, the mobile terminal changing the FA according to the command from the PC and obtaining wireless communication propagation environment information related to the changed FA from the BTS, and the PC re-outputting the FA-related wireless communication propagation environment information in the form of a graph and so on based on the FA-related wireless communication propagation environment information transmitted from the mobile terminal.

2. The method as claimed in claim 1, wherein if the system change command or the FA change command is sent from the PC while the mobile terminal initiates the system through its power-on, determines the FA by hashing the pre-input MIN and is in a standby state that a wireless communication with the BTS is possible by the FA, the mobile terminal moves to the standby state for reception and changes the system or the FA sent from the PC.

3. An apparatus for measuring an FA (Frequency Assignment) wireless communication propagation environment established between a BTS (Base Transceiver Subsystem) and a mobile terminal at a certain place, the apparatus comprising:
the mobile terminal for performing a wireless communication with the BTS by an FA determined by hashing a pre-input MIN (Mobile Identification Number), and obtaining FA-related wireless communication propagation environment information by changing a system or the FA according to a system change command or an FA change command received from a PC linked to the mobile terminal if the system change command or the FA change command is sent from the PC; and
the PC linked to the mobile terminal and programmed to send the system change command or the FA change command to the mobile terminal, to read the FA-related wireless communication propagation environment information received from the BTS through the mobile terminal and to output the read FA-related wireless communication propagation environment information in the form of a graph and so on for monitoring.
